(19) United States
(12) Patent Application Publication
(10) Pub. No.: US 2024/0000028 A1
(43) Pub. Date: Jan. 4, 2024

(54) GROWING TRAY SYSTEM, METHOD AND FARMING SYSTEM

(71) Applicant: Ocado Innovation Limited, Hatfield, Hertfordshire (GB)

(72) Inventor: Lars Sverker Ture LINDBO, Hatfield, Hertfordshire (GB)

(73) Assignee: Ocado Innovation Limited, Hatfield, Hertfordshire (GB)

(21) Appl. No.: 18/253,751

(22) PCT Filed: Nov. 19, 2021
(86) PCT No.: PCT/EP2021/082269

§ 371 Date: May 19, 2023

(30) Foreign Application Priority Data
Nov. 20, 2020 (GB) 2018291.1

(51) Int. Cl. A01G 31/02; A01G 17/06

(52) U.S. Cl. CPC A01G 31/02; A01G 17/06

(57) ABSTRACT

A farming system, method and a growing tray system for propagating, growing and harvesting a crop, the growing tray system including an espalier frame defining a growing volume, being mounted to a base and configured to be movable with respect to the base between a substantially horizontal plane growing position and an open position.

### FIELD OF THE INVENTION

The present invention relates to a growing tray system, method and farming system. More specifically the invention relates to controlled environment farming techniques for tree and vine type plants.

### BACKGROUND

Conventional systems and methods for growing certain crops are well known. Most require large areas of land and need to be positioned in appropriate locations for the conditions required for the crops to be grown.

Indoor farming under artificial lights is gaining popularity for a large number of crops. There are many benefits associated with indoor farming, such as reduced needs for water, fertilisers and pesticides as well as increased control of taste, texture and other features of the crop.

More recently, advanced farming techniques such as hydroponics, aeroponics and other such cultivation systems have led to the ability to grow high quality crops indoors with very high utilisation of lighting, water and fertiliser. These systems have however been less efficient in terms of land use, capital and labour.

The benefits from controlled environment, indoor and or vertical farming systems are likely to become more pronounced as improved infrastructure components such as more efficient and cheaper lights, and cheaper electricity become available.

Presently, mainly short plants, such as herbs and leafy greens are grown indoors under artificial light.

UK application WO202030825 A1 (Ocado Innovation Limited) “Hydroponics Growing System and Method”, the contents of which are incorporated herein by reference, discloses a hydroponic growing system. Seeds are pre-treated and germinated in a ‘high care’ portion to reduce contamination during germination. Seedlings are then moved to a growing room in support vehicles containing growing which trays move along a frame or rack as the crop grows and until the crop is ready for harvesting. The system disclosed includes illumination apparatus above each growing station, and a recirculating irrigation system for providing nutrients to a growing crop. The irrigation system uses mains water blended with nutrients, which is pumped to the growing crop. Water which drains from the racks is reintroduced to the water blend to minimise waste water.

Many of the economically most important crops are however vine or tree crops, such as tomatoes, cucumbers, apples, pears and peaches.

Tree and vine crops are typically commercially grown in a two-dimensional pattern of upright in rows. The plants may be supported by metal, wood or rope structures, often referred to as espaliers. The support structure is intended to guide plant growth.

Commercially viable indoor farming solutions require maximisation of efficient use of space and other resources such as lighting, fluids, and labour. In an indoor farm, a traditional espalier-type arrangement is not ideal, since the layout restricts the density at which the plants can be grown. Also mechanisation of cultivation and harvesting is difficult.

The present invention aims to further develop indoor growing systems and methods, in particular for producing crops from tree and vine type plants.

It will be appreciated that the present invention also aims to maximise the yield, improve efficiency in terms of use of assets, resources and services required by the crop. For example, but not limited to efficiencies, may comprise: reduced needs for water; reduced needs for fertilisers and pesticides; increase in the control of taste; increase in the control texture and other features of the crop; efficiencies in the use of artificial lighting; efficiencies in maintenance of the facilities; improved utilisation of space, improved safety, an increase in automation and corresponding decrease in labour. Overall, the present invention aims to address issues enabling more growth in a smaller space with less electricity consumption, less capital expenditure, less maintenance and less labour cost.

It will be appreciated that the ability to increase control of the growing environment all aspects of the growth process may allow conditions to be adapted in ways that may mimic or replicate some of the best natural conditions thereby enhancing the qualities of the crop. In some cases it may be possible to achieve desirable crop qualities that are impossible in nature. Thus, it may be possible to increase diversity and range across different types of crops.

Furthermore, the benefits from controlled environment and or vertical farming systems are likely to become more pronounced as improved infrastructure components such as more efficient and cheaper lights, and cheaper electricity become available.

The present disclosure describes systems, methods and devices for improving the efficiency of these types of techniques.

### SUMMARY OF THE INVENTION

Aspects of the invention are set out in the accompanying claims.

A growing tray system for propagating, growing and harvesting a crop is provided, the growing tray system comprising: an espalier frame means defining a growing volume, being mounted to a base and configured to be movable with respect to the base between a substantially horizontal plane growing position and an open position.

In the open position, the frame may be angled from the substantially horizontal plane.

The espalier frame means may be hingedly mounted along one edge to the base.

The espalier frame means may comprise a plurality of upright (z-direction) members connected at the lower end and connected at the upper end by a plurality of horizontal bars.

In this way, the traditional concept of a conventional two-dimensional espalier is preserved, but the espalier is turned from vertical to horizontal.

The espalier frame provides a horizontal support frame to support trees, vines and other plants within the growing volume. Typically leaves grow towards the light, and fruit i.e. the crop is relatively heavy and tends to hang down. By arranging the espalier frame in a horizontal plane, rather than a vertical plane, the foliage and fruit will tend to separate with the foliage above the frame, and the fruit below the frame. In this arrangement, when the tray is illuminated from above, substantially all of the light will fall on the leaves, and the leaves will not be shaded by growing fruit. Any light that illuminates fruit is effectively wasted. Avoiding shading from fruit may be particularly important when there is a large amount of fruit on the vine or branch, for example when the fruit is approaching readiness for harvesting. In this way, the fruit is away from the light source as far as possible. The arrangement makes more efficient use of the light available within the indoor farm.

The frame is mounted on a base along one edge and movable between the horizontal plane for growing and an open position, where the distal edge is moved away from the base and the plane of the frame is angled in an upwards direction. Typically, the upright members are connected at the upper end along and across rows, and connected at the lower end only along the long sides of rows and across the ends. In this way, the underside of the frame or growing volume may be easily accessed. As a result, the upright members of the frame may be relatively short and the overall height of the tray system may be relatively short as it is not necessary for users or machines to work beneath the frame. It will be appreciated that the relatively short frame and overall tray height allows trays to be stacked or placed on tiered racks during periods when the plants are growing and do not require attention. As a result, the trays allow use of the space within the indoor farm to be maximised in the vertical direction. Furthermore, in an open position, the fruit may be easily harvested and the plants tended to. These cultivation processes may be carried out manually, using machines for semi- or full-automation. Where it is intended that the cultivation is carried out manually, it will be appreciated that the depth (x-direction) of the tray may be sized so that a worker can easily reach across the tray to the hinged edge to reach and work on all parts of the plant.

It will be appreciated that the espalier frame may be moveable between the growing position and the open position manually, assisted with a motor, or the movement may be fully automated. The espalier frame may be supported in the open position by a pneumatic arm or other similar means. The espalier frame may have partially open or intermediate positions between the horizontal growing position and the fully open position.

The espalier frame means may comprise a number of interchangeable sections extending in a first direction (x-direction) and arranged side-by-side in a second direction (y-direction) to provide a corresponding number of parallel growing rows.

The base may comprise an irrigation layer. A sheet may be provided over the irrigation layer.

When plants are first propagated in the tray system having an espalier frame, they will be planted near to the mounting point of the espalier frame on the base. The root system will be arranged in the base and may be supported by a substrate according to the growing approach in use. The growing system may be a ‘traditional’ environment i.e. soil; liquid (hydroponic); or aerosol (aeroponic) environment. The roots may be physically supported by a medium such as perlite, Rockwool™, vermiculite, coco fibre, sand or gravel. Typically, plant roots do not thrive when exposed to light. Therefore, a sheet or membrane as a light barrier that shades the roots may be provided. A cover or sheet may be necessary where soil is not used. The membrane may also prevent the roots and substrate from becoming contaminated with debris from the shoot system and other things within the indoor farm.

An irrigation layer or irrigation system may be provided within the base of the tray. The irrigation system may be a fluid management system providing the tray with a nutrient solution to feed the plants, and fluid drainage and recycling.

It is intended that the shoot system will be arranged on or around the espalier frame. Typically the shoot system will be trained with a main stem extending in the first direction. In this way, the plants may be arranged in a number of parallel rows across the frame.

The espalier frame may be used for growing different types of crops. The best suited types of crops may be divided into two types. The first type being slow growing trees crops, such as apples, peaches, grapes and cherries, which typically give one harvest per year for many years. For slow growing crops it may be most effective to grow and maintain a small number of plants with long branches. The other type is fast growing vines typically having one harvest per week or so, such as tomatoes, cucumbers and peppers. For fast growing crops, it may be most effective to have a large number of plants where the vines are limited to the length of a frame row (x-direction). It will be appreciated that the optimal length of vine or branch will depend on the crop.

Vines and branches may be trained to follow straight path to the end of a row, and then curved around to extend along a second a row, adjacent to the first row. In this way, vines and branches are not limited in length by the depth or width (x-direction) of the tray system. Instead, the vines or branches may extend to occupy additional space along the length (y-direction) of the tray system.

Attaching branches or vines to the espalier frame structure helps to maintain an orderly and efficient system.

The espalier frame and corresponding base portion may be considered to comprise a number of sections, where one section occupies a single row (x-direction), and the sections are arranged in a compact formation along the length (y-direction) of the tray system. Considering a tray which contains a number of young plants, each row or section of the espalier frame may support a single plant. Once the plants have reached the end of their row the plant may either be pruned to limit the length of the branch or vine, or a controller may decide to allow the branch or vine to continue to increase in length onto another section of the espalier frame. By having interchangeable sections i.e. the ability to disconnect a single section of the espalier frame from the mounting, and reconnect another section of espalier frame, a controller has the ability to rearrange plants within the tray system and space out plants as they require more room. In other words, sections of the espalier frame, may be swapped into the tray to accommodate a growing plant, and excess plants may be moved to a second tray so that each plant has sufficient space.

In this way, use of the tray may be maximised at all stages during the life cycle of the plants, whether they are young and have relatively short vines or branches, or more mature with relatively long vines or branches.

Further, a regular and orderly system may provide improvements in: light penetration; ventilation; and efficiency of harvesting.

The tray system may further comprise sensor means and communication means for monitoring the crop. Accordingly, the tray system may comprise suitable connections for supporting these services, for example, a power connection. The sensor means may collect data of the crop, and environment around the crop. The communication means may relay the collected data to a controller. Further, the communication means may receive control signals from a controller.

The tray system may be designed to be stackable, for efficient storage when not in use.

A system and method of propagating, growing and harvesting a crop using the tray system disclosed herein is provided.

The system may be an indoor or vertical farming system. The system may provide a controlled environment to produce high quality crops while maximising the use of resources such as electricity, water and space.

The farming system may comprise one or more trays systems as described herein; one or more growing locations for accommodating the one or more trays; and one or more work stations for carrying out one or more manual, semi-automated, or automated processes.

The farming system may further comprise: one or more load handling devices.

The farming system may further comprise a controller means.

Each of the growing locations may be arranged to provide one or more, or all of services required to grow the crop. For example, lights may be provide positioned above each of the tray systems and the growing location may provide fluid connections to the tray system. The fluid connection may be a physical connection such as a pipe connection, or the fluid connection may be arranged with an outlet into the tray system, and drip tray to collect and recycle used fluid.

The growing locations may comprise racking for receiving tray systems. The racking may have integrated services such as lighting and a fluid system.

The growing locations may further comprise netting located between the tray system and the lighting, and extend across a similar area as the tray to limit upward growth of the crop.

The farming system may further comprise one or more sub-systems for controlling air flow speed, air flow direction, air compositions, air temperature and humidity, or any other necessary environmental control systems. The farming system may comprise a high-care or ‘clean’ facility, where pests and diseases are kept to a minimum. Alternatively, for some crops it may be possible to achieve unique flavours and or textures by controllably introducing diseases caused by bacteria, fungi and or viruses.

Load handling devices or other MHE may be used to move the tray systems between growing locations and workstations. Load handling devices may be manually operated, semi- or full-autonomous and controlled by a controller.

Workstations may be used for carrying out processes necessary for cultivating the crop. It will be appreciated that some work may be carried out at growing locations. Workstations may be arranged to be dedicated to specific tasks or functions or work stations may be arranged to be multi-functional. Processes carried out may be performed by a user or by automated or semi-automated equipment. It will be appreciated, that whether work is carried out by a user or a machine, a ‘goods-to-man (or processing equipment)’ system is provided. A ‘goods-to-man (or processing equipment)’ system may provide increased efficiencies in the time required to carry out processes and the operator, whether user or machine, does not need move between locations within the farming system facility.

The controller may be used to control some or all aspects of the farming system. The controller may control each of the sub-systems. The controller may control services provided to the crop. The controller may control the environment within the farming system. The controller may control when processes are carried out on crops. The controller may control load handling devices. Control decisions may be based on feedback provided by collected data from the tray systems or from sensor means located elsewhere within the system. Control decisions may be based on demand or future demand for the crop. Control decisions may be based on historic data.

The tray system may further comprise a canopy or net arranged on top of the espalier frame. In this way, the upward growth of the plant(s) may be limited or contained.

The method may comprise the steps of: planting a plant proximal to the mounted edge of the espalier frame, with the roots arranged within the base of the tray system and the stems and foliage arranged on the espalier frame; training a main stem of the plant to grow from the mounted edge of the espalier frame along a growing row.

Wherein the main stem of the plant may be supported by upper horizontal bars of the espalier frame means. Wherein the foliage of the plant may be arranged substantially above the espalier frame. Wherein the plant crop may be arranged to hang substantially below upper horizontal bars of the espalier frame.

Further, the method may comprise further training the main stem of a plant to follow a curvy linear path to a second growing row, adjacent to a first growing row.

The method may further comprise moving the espalier frame means to the open position and carrying out one or more manual, semi-automated, or automated processes.

Processes that may be carried out comprise: plant cultivation processes; pollinating the crop; harvesting the crop; and pruning the crop. Pollination may be achieved by introducing pollinating insects into system, or pollination may be achieved using a mechanical robot arm.

Pruning may help with plant growth and also with maintaining an orderly system.

In this way, the tray system, method and indoor farming system provide a system that may be increasingly mechanised, where growth trays can be kept under lights for extended periods of time and the trays can be moved to dedicated stations for harvesting, pollination, pruning or other processes as and when required.

It will be appreciated that some fruits, such as tomatoes may be harvested weekly or even every few days, whereas other fruits are more typically and traditionally harvested only once a year when outdoors and only 2-4 times a year when grown indoors. Further, for some plants the fruit will ripen all at the same time on one stem, while for other plants the fruit will ripen differently along the stem. Accordingly, different harvesting approaches may be required for different plants.

It will be appreciated that the tray system, method and framing system disclosed herein, provides flexibility to optimise the approach and conditions required for efficiently growing different types of plants, and for efficiently arranging plants within a limited space.

Embodiments of the present invention will now be described, by way of example only, with reference to the accompanying drawings, in which like reference numerals are used for like features, and in which:

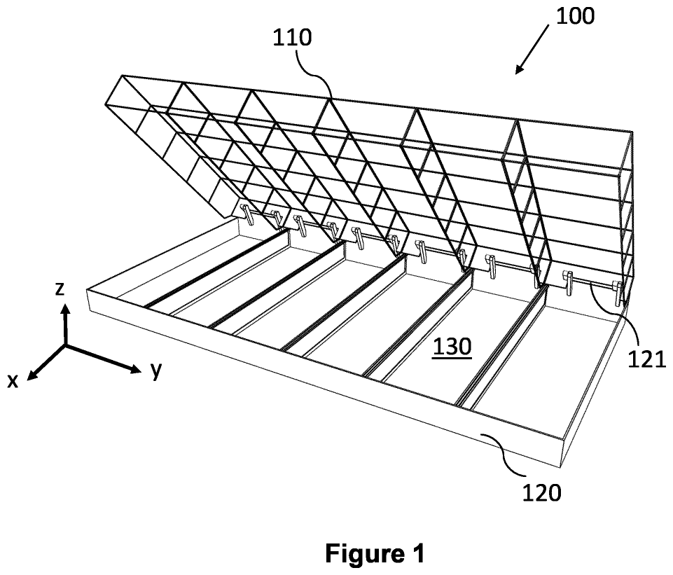

FIG. 1 shows a perspective view of a growth tray system comprising a horizontal espalier frame means and a base where the frame means is in an open position;

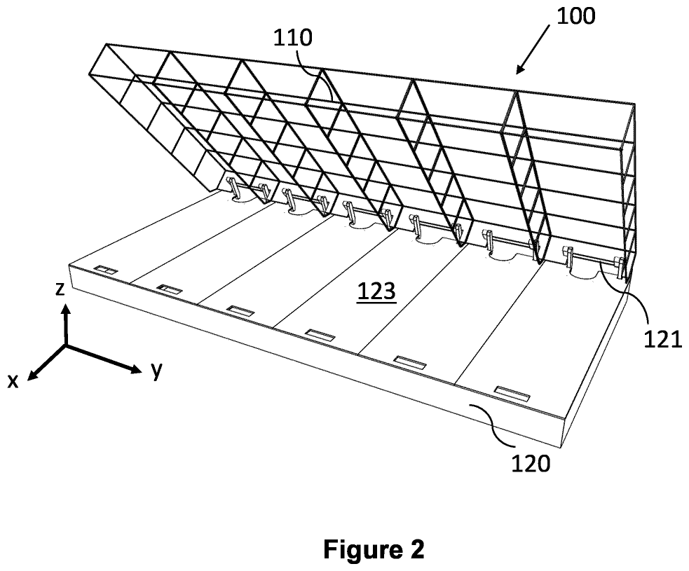

FIG. 2 shows a perspective view of a growth tray system comprising a horizontal espalier frame means and a base where the frame means is in an open position, with sheets covering the base;

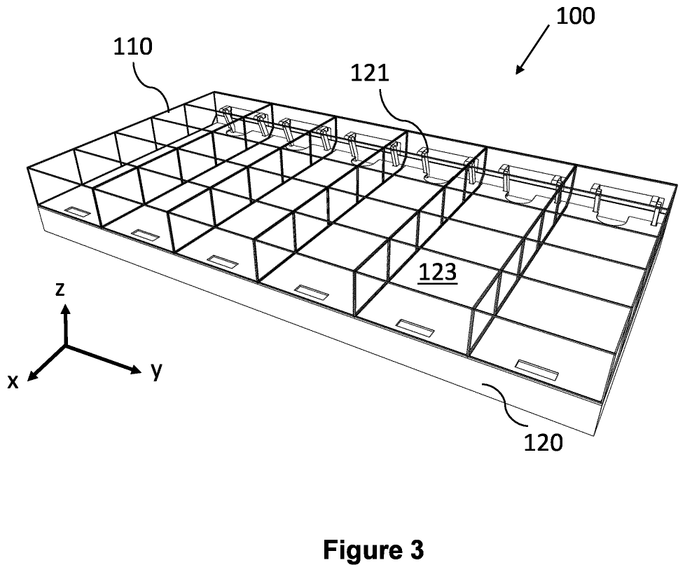

FIG. 3 shows a perspective view of a growth tray system comprising a horizontal espalier frame means and a base where the frame means is in a growing position;

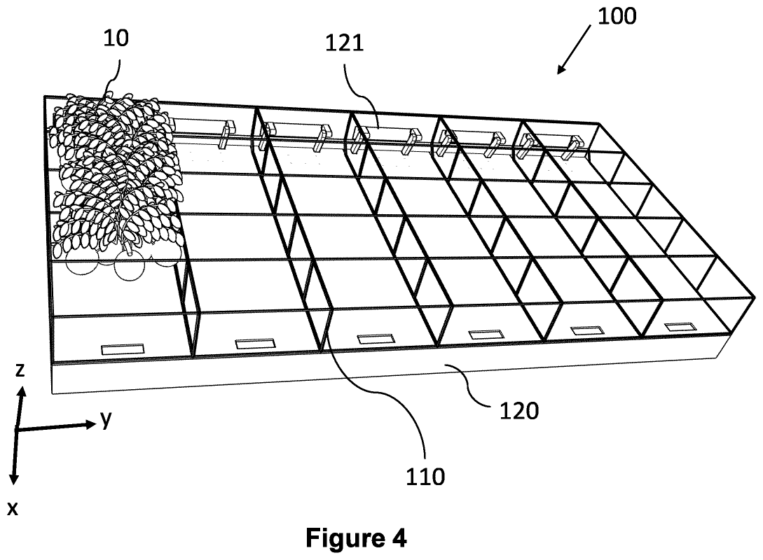

FIG. 4 shows a perspective view of a growth tray system comprising a horizontal espalier frame means and a base, with a fruiting plant growing along a row, where the frame means is in a growing position;

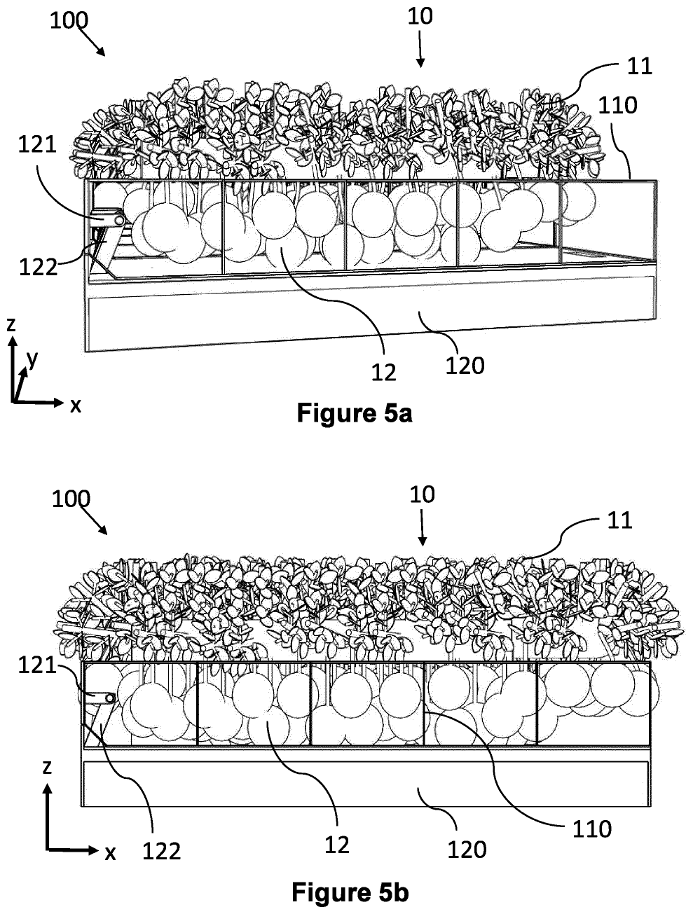

FIGS. 5a and 5b shows a z-x view of a growth tray system comprising a horizontal espalier frame means and a base, with a fruiting plant growing along a row having foliage substantially above the espalier frame and fruit handing substantially below the upper horizontal bars where the frame means is in a growing position;

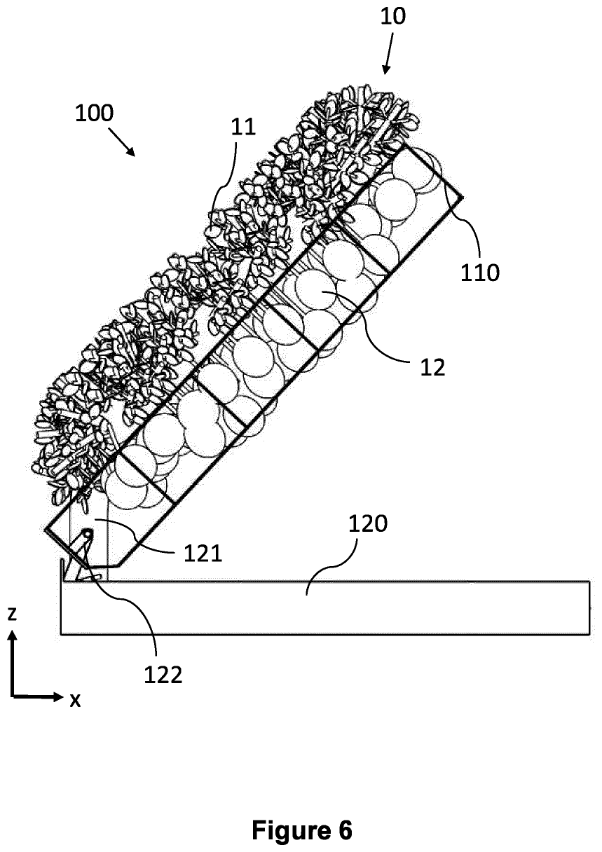

FIG. 6 shows a z-x planar view of a growth tray system comprising a horizontal espalier frame means and a base, with a fruiting plant growing along a row having foliage substantially above the espalier frame and fruit hanging substantially below the upper horizontal bars where the frame means is in an open position;

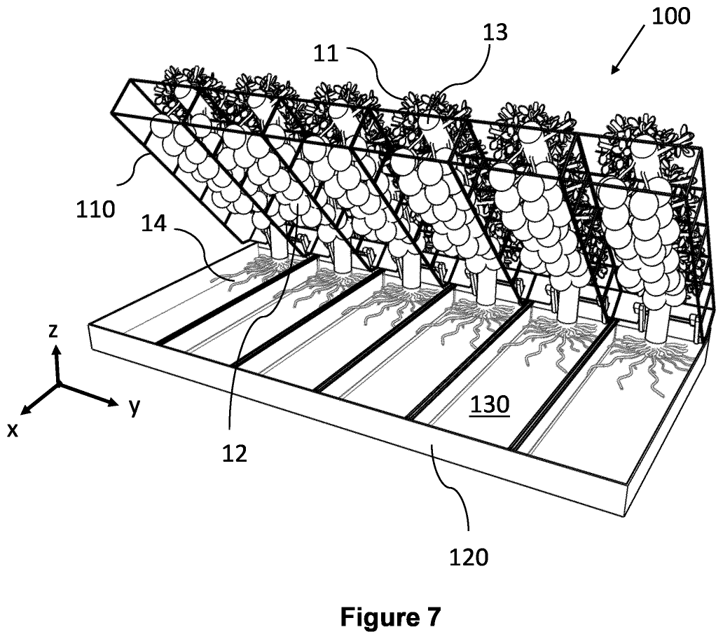

FIG. 7 shows a perspective view of a growth tray system comprising a horizontal espalier frame means and a base, with a fruiting plants growing along rows having foliage substantially above the espalier frame and fruit handing substantially below the upper horizontal bars where the frame means is in an open position and the base covers are removed;

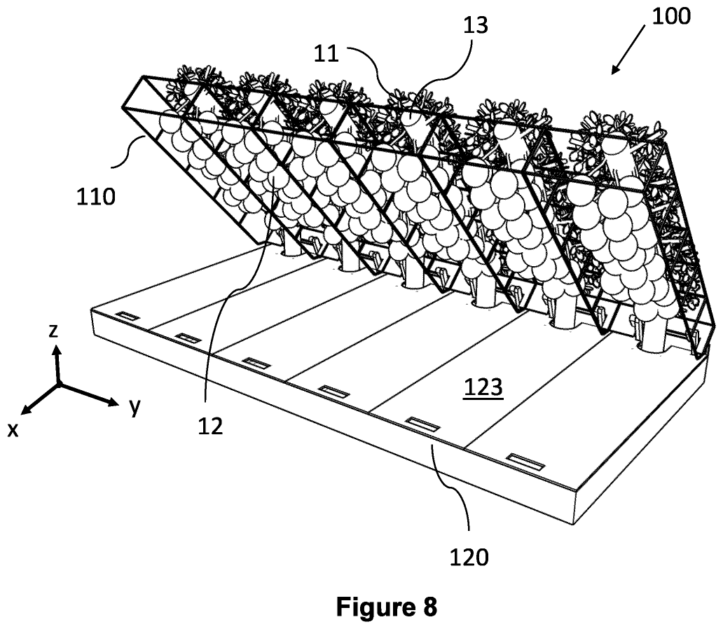

FIG. 8 shows a perspective view of a growth tray system comprising a horizontal espalier frame means and a base, with a fruiting plants growing along rows having foliage substantially above the espalier frame and fruit handing substantially below the upper horizontal bars where the frame means is in an open position;

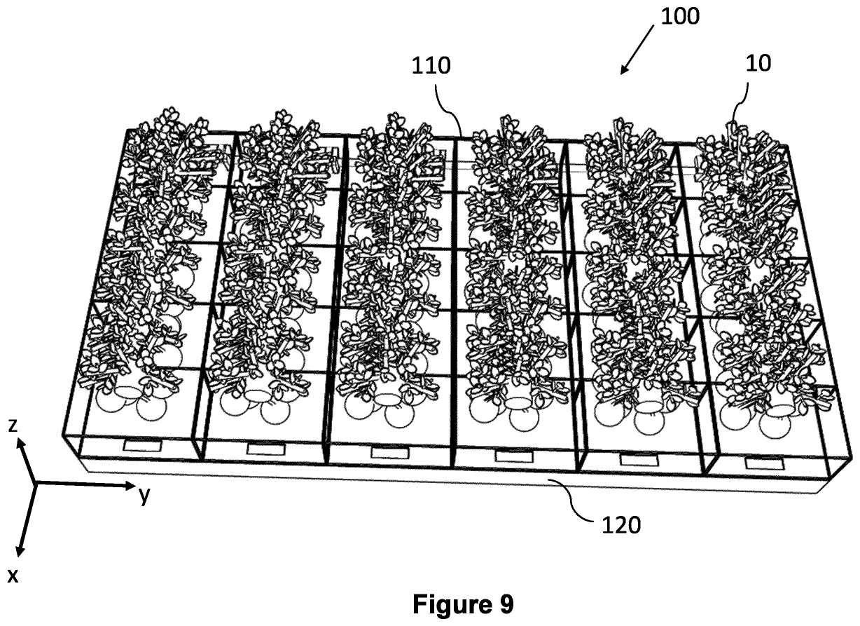

FIG. 9 shows a top down view of a growth tray system with a fruiting plants growing along each of the x-direction rows and the espalier frame in the growing position;

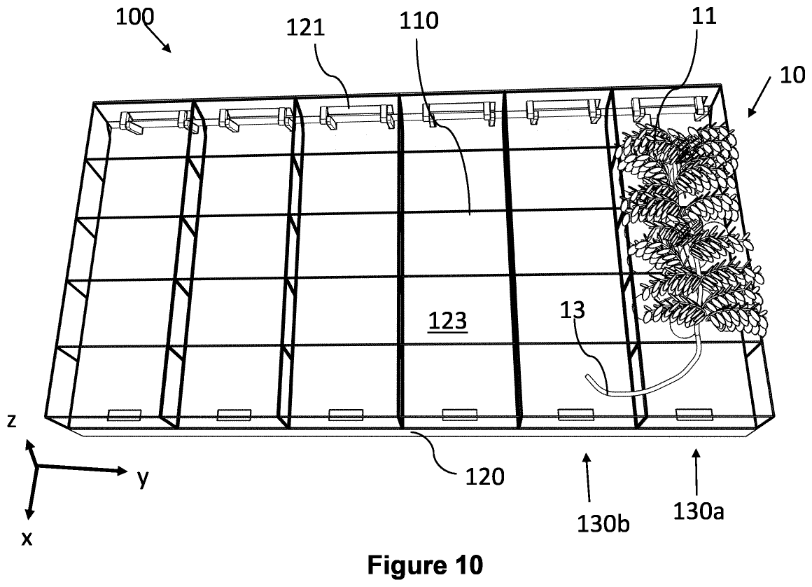

FIG. 10 shows a top down view of a growth tray system with a fruiting plant growing along a first x-direction row and being trained in a curvy linear path to a second x-direction row;

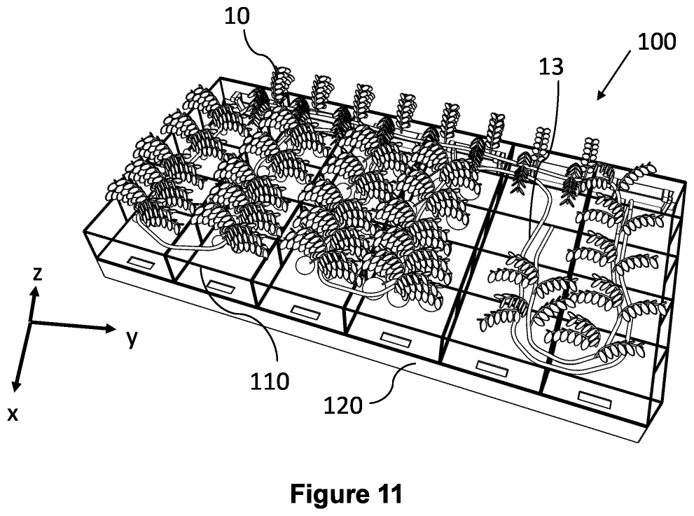

FIG. 11 growth tray system with a fruiting plant having been trained around in a curvy linear path to a occupy additional rows, where one part of the plant is more mature than a second part of the plant which is less well established;

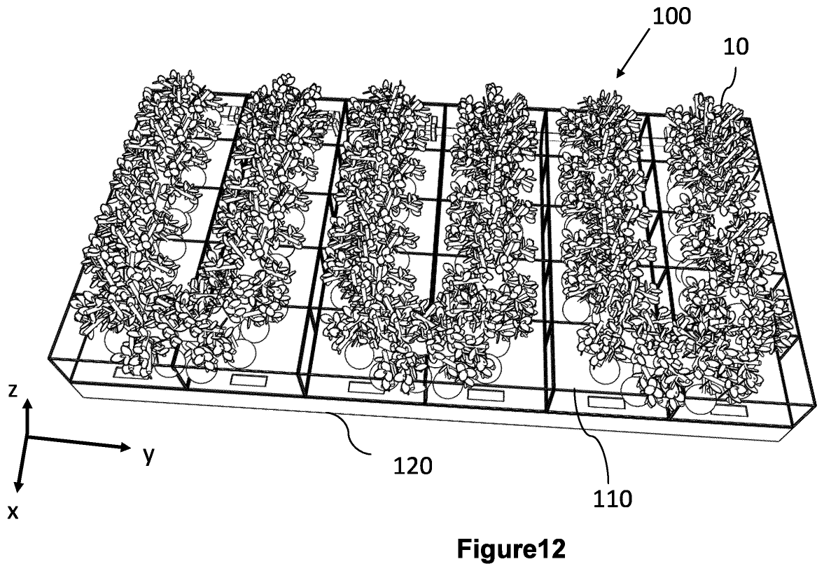

FIG. 12 shows a top down view of a growth tray system with three fruiting plants each trained to grow along two adjacent x-direction rows;

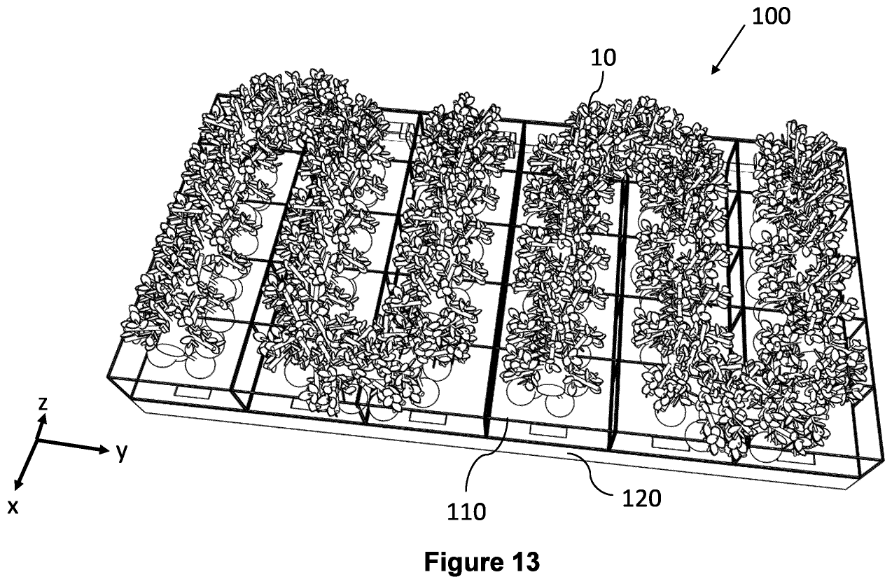

FIG. 13 shows a top down view of a growth tray system with two fruiting plants each trained to grow along three adjacent x-direction rows;

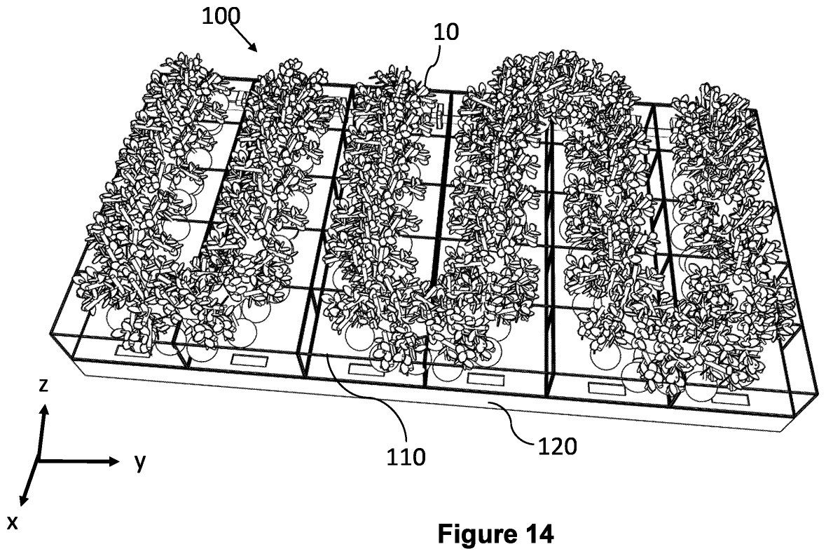

FIG. 14 shows a top down view of a growth tray system with two fruiting plants, a first plant occupying two adjacent x-direction rows, and a second plant occupying 4 adjacent x-direction rows;

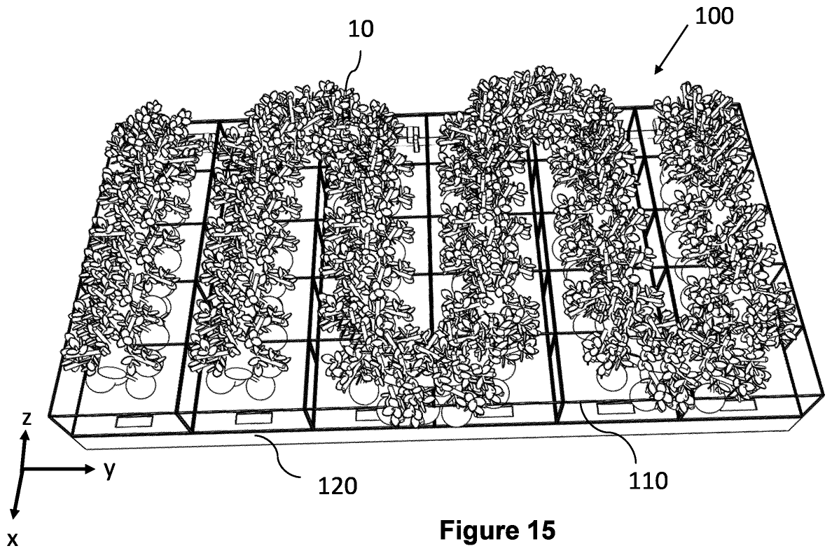

FIG. 15 shows a top down view of a growth tray system with two fruiting plants, a first plant occupying five adjacent x-direction rows, and a second plant a single x-direction rows;

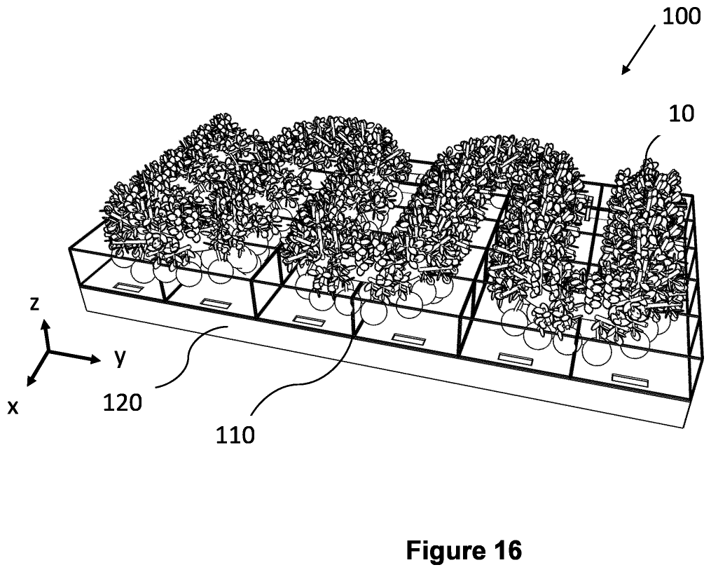

FIG. 16 shows a top down view of a growth tray system with a single fruiting plant following a serpentine path occupying all the entire espalier frame;

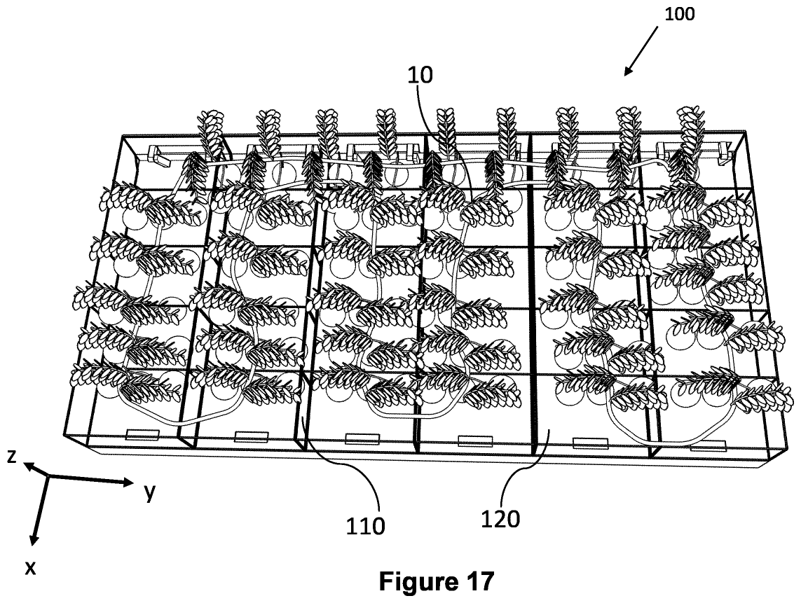

FIG. 17 shows a top down view of a growth tray system with a single fruiting plant following an alternative path occupying all the entire espalier frame;

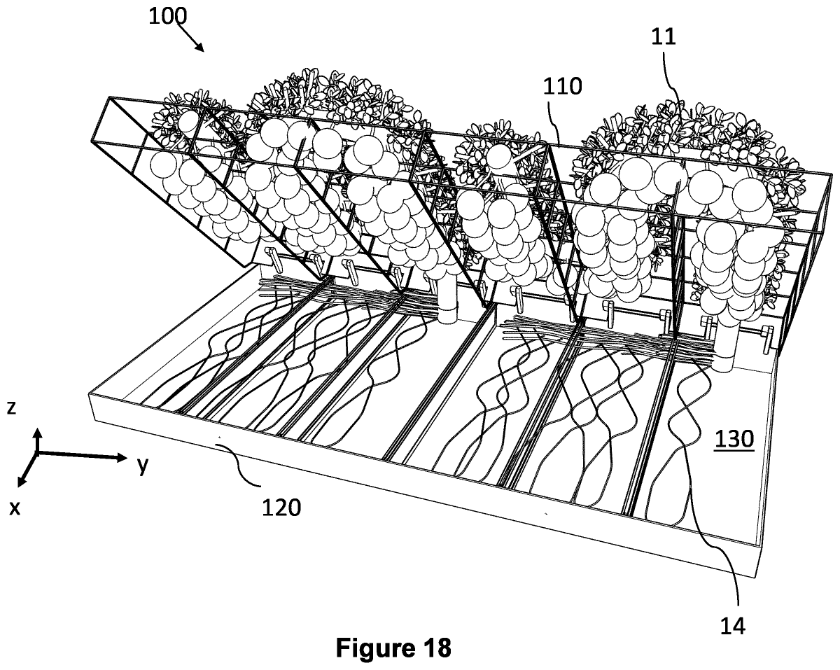

FIG. 18 shows an open tray system with two fruiting plants, where for each of the plants a first branch follows a serpentine path and a second branch occupies a single row; and

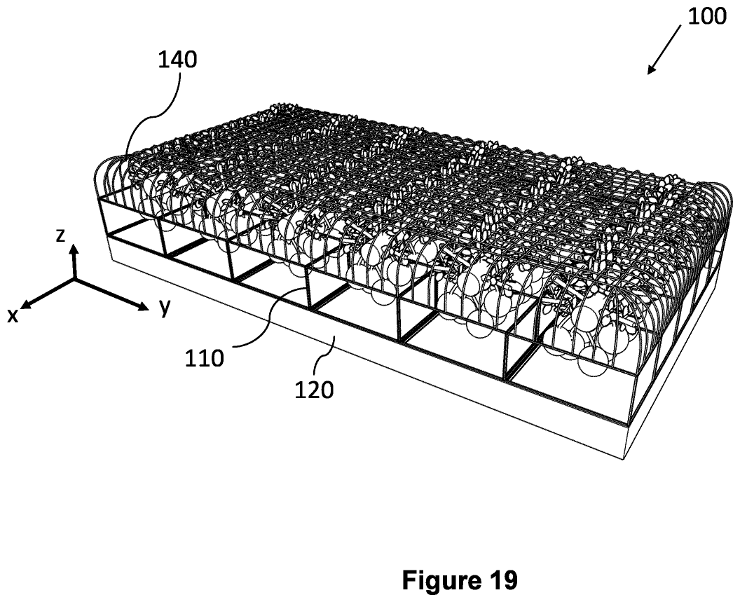

FIG. 19 shows a growing tray system with a canopy covering the foliage of the plants.

### DETAILED DESCRIPTION OF DRAWINGS

The present invention may form part of a larger system. It will be appreciated that the system, methods and devices described herein are exemplary only, and other combinations and configurations of the apparatus and equipment described are anticipated by the inventors of the present disclosure without departing from the scope of the invention described here.

FIGS. 1-3 show a growth tray system 100 comprising an espalier frame 110 and a base 120. As can be seen in FIG. 1, the base is divided into a number of sections 130. As shown in FIG. 2, the sections 130 are covered with a light barrier, cover or sheet 123. In FIGS. 1 and 2 the tray system 100 is shown in an open position, and in FIG. 3 the tray system 100 is shown in a growing position. As shown, the espalier frame 110 is in a substantially horizontal plane when in the growing position, and the espalier frame 110 is at an inclined angle relative to the base 120 when open. The espalier frame 110 is moveable relative to the base 120.

Considering the espalier frame 110 in the growing position, the espalier frame 110 comprises a plurality of upright members connected at the lower end and connected at the upper end by a plurality of horizontal bars. The frame provides a regularly repeating structure extending in two-dimensions for supporting a plant. The horizontal bars form a grid-like pattern to cover the available surface area of the tray system 100.

The espalier frame 110 is attached to the base 120 by a series of mounts 121 located along one edge of the base 120. The frame 110 extends from the attachment points or mounts 121 to the opposite or distal edge of the tray system 100 in the x-direction. A mount 121 is provided for each section 130 of frame in the y-direction. In the open position, where the frame is rotated from the horizontal plane about the attachment point or hinge 121 along one side of the tray system 100. The frame 110 may be held in the open position by a pneumatic arm 122.

As can be seen in FIGS. 4-19, in use, a fruiting plant 10 may be supported on the frame. The root system 14 sits in the base 120 of the tray, and the shoot system is supported by the frame 110. Typically, the foliage 11 sits substantially above the espalier frame 110 and fruit 12 hangs substantially below the upper horizontal bars. In FIGS. 7 and 12 the sheets 123 are not present in the drawing and the roots 14 of the plant may be seen, arranged in the sections 130 of the tray system.

Naturally, foliage tends to have an upward growth habit against gravity and towards the sky above, and fruit 12 tends to hang downward due to its weight. When the plant 10 is supported by a horizontal frame the separation of plant parts will typically occur naturally as can be seen in FIGS. 5a, 5b and 6.

FIGS. 6-8 show the frame in an open position. In this position, the fruit 12 hanging below the upper end of the frame is easily accessible from underneath the frame 110. It will be appreciated that the upright members of the frame are not connected across rows at the lower end, to allow easy access to the fruit 12 along the row. This may be advantageous particularly when using an semi- or fully-automated harvesting device. However, while some connections may be provide across the frame on the lower end of the uprights for structural stability of the frame, typically these will be more spaced out and fewer compared with the horizontal bars on the upper end of the uprights. Further, when the sheets 123 are removed, as shown in FIG. 7, it is possible to carry out cultivation processes on the roots whilst the plant 10 remains supported in the tray system 100.

It will be appreciated that in order for the tray system 100 to move between open and horizontal or growing positions, the main stem 13 or trunk of the plant 10 should be located proximal to the hinge point 121 to limit the amount of strain and stretch necessary to move the espalier frame 110, and the stem 13 will need to be flexible and supple enough to be bent. For some crops with stiff root structures, it may be necessary to train the root sideways. For some crops the root and stem systems may be arranged or the tray system 100 modified to provide torsional movement when opening the espalier frame 110, in order to minimise any damage to the plant. For another crops there may be a combination of torsional and bending of the main stem when opening the frame.

The espalier frame 110 helps to keep the plants 10 growing in an orderly and controlled fashion. This may be maintained by carrying out pruning and other cultivation processes. As can be seen in FIGS. 7-9, six individual plants 10 are growing on the tray system, each extending in its own section 130 of the base, and the shoot system with foliage 11 and fruit 12 extending from the hinge to the distal side of the frame along an x-direction row of the frame 110 corresponding to the respective base section 130. In this way, the roots 14 of separate plants 10 are prevented from becoming entangled. At the end of the row, the main stem 13 has been cut so that the terminal bud does not cause the stem 13, branch or trunk to grow longer, and side branches extend from the main stem 13 within the growing volume of the row. In this way, the number of plants 10 arranged in the tray is maximised.

It will be appreciated that some plants are more effective or commercially economical when they are allowed to grow longer branches or vines than a single tray system row allows. As shown in FIG. 10, a single plant 10 has grown from the hinged edge to the final grid cell in its initial row 130a. In this case, rather than cutting the terminal bud of the main stem 13, the stem 13 is trained into the adjacent row 130b or section of the espalier frame 110, following a curvy linear path to continue growing from the distal side of the tray and return to the hinged edge. FIG. 11 shows an older plant 10 compared with FIG. 10, where the first four rows of the tray 100 are supporting a mature part of the plan 10, and the last two rows of the tray 100 are supporting a less well established part of the plant 10. In this way, longer branches or vines may be grown using the tray system.

FIGS. 12-18 show various configurations of larger plants 10 arranged in the growing tray system. It will be appreciated that, if allowed, as plants grow longer/larger they will occupy a larger number of frame grid spaces, and therefore fewer plants 10 per tray can be accommodated. In order to continue making maximum use of the tray space available, frame rows or sections may be modular and interchangeable. In this way, until more growing length is required, plants may be arranged next to each other. When a plant 10 reaches the end of a row, the plants may be spaced apart, using additional bases 120 as necessary, and placing an empty espalier frame 110 and base section 130 next to the growing plant that can be expanded onto. It will be appreciated, that the roots 14 in the base section 130 may be moved together with the shoot system and corresponding espalier frame section 110. As can be seen in FIG. 18, the sectioned aspect of the base 120 helps to ensure that the roots 14 are kept orderly and plants 10 can be moved within the tray system 100 without having issues of roots being entangled with neighbouring plants. For example, a barrier such as an upright divider may be positioned between base sections 130. This approach can continue until a single plant covers an entire tray system.

FIG. 19 shows a tray system with a plant, where a canopy 140 is positioned over the foliage of the plant. The canopy has an open frame to allow light through to the plant. The canopy may take any form, such as a net or cage. The canopy is used in order to limit the upward growth of the plant and keep the plant orderly.

It will be appreciated that slow growing plants such as fruit trees may take years before covering an entire tray, whereas fast growing plants may cover an entire tray more quickly.

It will be appreciated that, the growing tray system, method and farming system described herein provides an increased density and more efficient facility. Accordingly, the facility provides an efficient and cost effective use of land.

It will be appreciated that, advantageously, the tray arrangement is relatively simple in design, with minimal interaction or connectivity required. Accordingly, the growing facility may be relatively cheap, straight-forward and quick to construct. It may be possible to construct the facility within existing buildings, or within multi-function buildings.

It will be appreciated that the load handling of trays between locations may provide improvements in automation, and environmental control.

It will be appreciated that the irrigation, lighting and sensing allow for customisation of the localised environment for specific trays.

Advantageously, the system readily supports full automation of all routine production or cultivation tasks as the load handling devices provide conveyance through workstations; and workstation could be automated or robotic.

The farming system described above with reference to the figures allows control of the growing environment and thus reduces the risk of microbiological contamination. In addition, the modular nature of the system allows for efficient use of space and ready scalability. The length, width and height of the tray system, and number of tray systems within the farming system can be chosen to fit the available space and processes in place.

Accordingly crop yields and economics may be improved, and the environmental impact is minimised.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

It will be appreciated that the organisation of the plants in rows on the espalier frame makes it possible to implement improved automation of harvesting, as fruit will tend to be separate from foliage and will tend to be in expected and consistent locations relative to the structures.

It will be appreciated, that the tray system and workstations can be proportioned to be ergonomically advantageous for users. Accordingly, users may be able to work more comfortably, more consistently and more efficiently.

It will be appreciated that a farming system, method and devices can be designed for a particular application using various combinations of devices and arrangements described above. It will be appreciated that the features described hereinabove may all be used together in a single system. In other embodiments of the invention, some of the features may be omitted. The features may be used in any compatible arrangement. Many variations and modifications not explicitly described above are possible without departing from the scope of the invention as defined in the appended claims.

In this document, in some instances the terms “crop” and “fruit” may have been used interchangeably and intended to mean the same thing. The term “fruit” is not intended to limit the disclosure to any particular type of fruit or even type of crop. The “crop” may be a part of a plant which is not a “fruit”.

In this document, the term “load handling device” may be considered to be a tray handling device. The load handling device is a type of MHE or material handling equipment.

In this document, the language “movement relative to a gap” is intended to include movement within the gap, e.g. sliding along the gap, as well as movement into or out of a gap.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

1. A growing tray system for propagating, growing and harvesting a crop, the growing tray system comprising:
an espalier frame means defining a growing volume, being mounted to a base and configured to be movable with respect to the base between a substantially horizontal plane growing position and an open position.

2. A growing tray system according to claim 1, wherein the espalier frame means is hingedly mounted along one edge to the base.

3. A growing tray system according to claim 1, wherein the espalier frame means comprises,
a plurality of upright members connected at the lower end and connected at the upper end by a plurality of horizontal bars.

4. A growing tray system according to claim 1, wherein the espalier frame means comprises:
a number of interchangeable sections extending in a first direction and arranged side-by-side in a second direction to provide a corresponding number of parallel growing rows.

5. A growing tray system according to claim 1, wherein the base comprises:
an irrigation layer.

6. A growing tray system according to claim 1, wherein a sheet is provided over the base.

7. A growing tray system according to claim 1, comprising:
a canopy arranged on top of the espalier frame.

8. A method of propagating, growing and harvesting a crop using a tray system according to an espalier frame means defining a growing volume, being mounted to a base and configured to be movable with respect to the base between a substantially horizontal plane growing position and an open position, the method comprising:
planting a plant proximal to a mounted edge of the espalier frame, with roots arranged within the base of the tray system, and stems and foliage arranged on the espalier frame; and
training a main stem of the plant to grow from the mounted edge of the espalier frame along a growing row.

9. A method according to claim 8, comprising:
supporting the main stem of the plant by upper horizontal bars of the espalier frame means.

10. A method according to claim 8, wherein foliage of the plant is arranged substantially above the espalier frame.

11. A method according to claim 8, wherein a crop is arranged to hang substantially below the upper horizontal bars of the espalier frame.

12. A method according to claim 8,
training the main stem of a plant to follow a curvy linear path to a second growing row, adjacent to a first growing row.

13. A method according to claim 8, comprising:
moving the espalier frame means to the open position and carrying out one or more manual, semi-automated, or automated processes.

14. A system for propagating, growing and harvesting a crop in combination with a tray system, the system according to claim 1, comprising:
one or more tray systems according to claim 1;
one or more growing locations for accommodating the one or more trays and providing services; and
one or more workstations for carrying out one or more manual, semi-automated, or automated processes.

15. A system according to claim 14, comprising:
one or more load handling devices.
